(19) United States
(12) Patent Application Publication
(10) Pub. No.: US 2013/0085602 A1
(43) Pub. Date: Apr. 4, 2013

(54) Office Robot System

(71) Applicant: Hei Tao Fung, Fremont, CA (US)

(72) Inventor: Hei Tao Fung, Fremont, CA (US)

(21) Appl. No.: 13/628,046

(22) Filed: Sep. 27, 2012

Related U.S. Application Data
(60) Provisional application No. 61/542,808, filed on Oct. 4, 2011.

(51) Int. Cl. G06F 19/00

(52) U.S. Cl. 700/245

(57) ABSTRACT

An office robot system aiming at reducing both capital expenditure and operational expenditure in deploying various office robots to perform office works and functionalities is disclosed. The office robot system uses a distributed processing computing cluster, centralizing the heavy-duty robot system software computation and robot management function on the computing cluster, enables various office robots to be light-duty mobile computing devices, hence minimizing their computation and memory requirements, and enables the communications between the office robots and the computing cluster via proper corporate networking infrastructure. The office robot system facilitates deployment of heterogeneous robots with various computation capabilities. The robot system software stack is organized into layers of functional modules. Based on the computation load capable on a robot and the networking infrastructure capacity, the robot and the computing cluster divide the computation load.

### FIELD OF THE INVENTION

The present invention relates to a system of robots for office use.

### BACKGROUND

There have been various publications about office robots. Office robots, as the name may suggest, perform jobs in the office environment. Autonomous office robots may be used as visitor guides and for running errands, promoting products, cleaning, etc. There are also semi-autonomous office robots that facilitate worker interaction via video-conferencing; in that case, tele-operators may remotely control the office robots to look for and interact with co-workers in offices. At the technical level, the office jobs described may require the robots to be capable of recognizing some people, communicating with the people, locating the people, moving from place to place in the office while avoiding obstacles, and collaborating with other robots. While prior-art inventions focus on capability of an individual robot, such as its artificial intelligence, its electro-mechanical design, and distributed computing within the robot, the present invention relates to a system where autonomous and semi-autonomous office robots can be cost-effectively deployed and managed through wireless networking and distributed computing.

### SUMMARY OF THE INVENTION

The object of this invention is to provide a cost-effective system where various autonomous and semi-autonomous office robots can be deployed, controlled and managed. There are the capital expenditure (CAPEX) and operational expenditure (OPEX) aspects to be considered to make a system cost-effective. This invention can reduce both CAPEX and OPEX in deploying various office robots to achieve their desired functionalities. In this invention, we use a computing cluster that is capable of communicating to the robots via the corporate networking infrastructure. The computing cluster is to off-load the robots from the computation that is proved to be too burdensome to the robots. To achieve that, we architect the robot software into layers and functional modules within layers. Each robot is made capable of measuring the performance of executing the functional modules and the performance of passing information among the functional modules from one layer to another. The performance data is used for deciding which functional modules are to be executed on each robot and which complementary functional modules are to be executed on the computing cluster. There are a few advantages of this approach. Firstly, the many robots in the system can be built as low processing power and memory capacity mobile computing devices. The CAPEX on robots, as they are many in the system, can therefore be reduced. Secondly, there may be multiple versions of the robots, even of the same model, as technology is advanced along the years. Meanwhile, the software for the robots may also be upgraded along the years, hence demanding more processing power and memory capacity than before. It will be economical to keep even the older versions of the robots around. Our invention enables the older versions of the robots to execute as much as they can handle the upgraded software because the computing cluster off-loads the robots intelligently. Thirdly, the computing cluster centralizes the management and administration of the robots. Also, it enables collaborative learning and planning among the robots. For example, through collaborative planning, the robots are less likely getting into each other's way, hence requiring human intervention. All those translate into saving in OPEX. Lastly, the computing cluster can be built with state-of-the-art technologies in which computing power and memory capacity can be added to the computing cluster on demand. That is more manageable and more economical than constantly making sure the robots to be the same version or to run the same version of software.

Another object of this invention is disclosing how to partition the robot system software functional modules between the robots and the computing cluster. The functional modules that pertain specifically to the robot hardware are to be executed on the robots. Also, a safety monitoring module and the functional modules that the safety monitoring module depends on are to be executed on the robots. To enable the computing cluster to correctly interpret the data transferred from the robots, the robots should synchronize their clocks to the clock of the computing cluster and time-stamp the data.

Yet another object of this invention is disclosing how the performance data collected can be used to influence how the robots execute the functional modules and transfer the data to the computing cluster and the tele-operators' computers. The latency and bandwidth of the communications between the robots and the computing cluster may affect the image processing complexity. The latency and bandwidth of the communications between the robots and the tele-operators' computers may affect the actuation rates of robot actuators and the quality of the images transferred from the robots to the tele-operators' computers.

### BRIEF DESCRIPTION OF THE DRAWINGS/FIGURES

The present invention will be understood more fully from the detailed description that follows and from the accompanying drawings, which however, should not be taken to limit the disclosed subject matter to the specific embodiments shown, but are for explanation and understanding only.

FIG. 1 illustrates an example of a deployment of the invention.

FIG. 2 illustrates an embodiment of the robot system.

FIG. 3 illustrates an embodiment of robot system software.

FIG. 4 illustrates a partition of functional components.

FIG. 5 illustrates an embodiment of the functions performed on a robot.

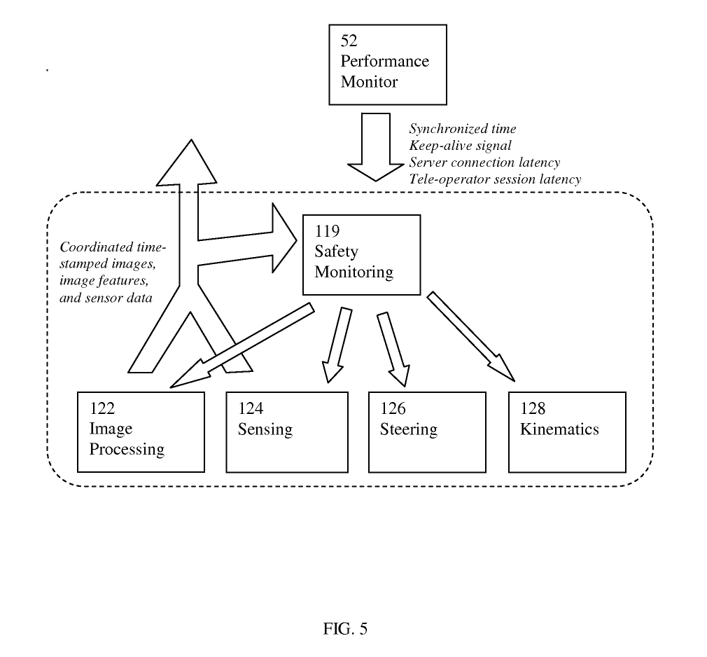

FIG. 6 illustrates an embodiment of the methods implemented on a robot.

### DETAILED DESCRIPTION OF THE INVENTION

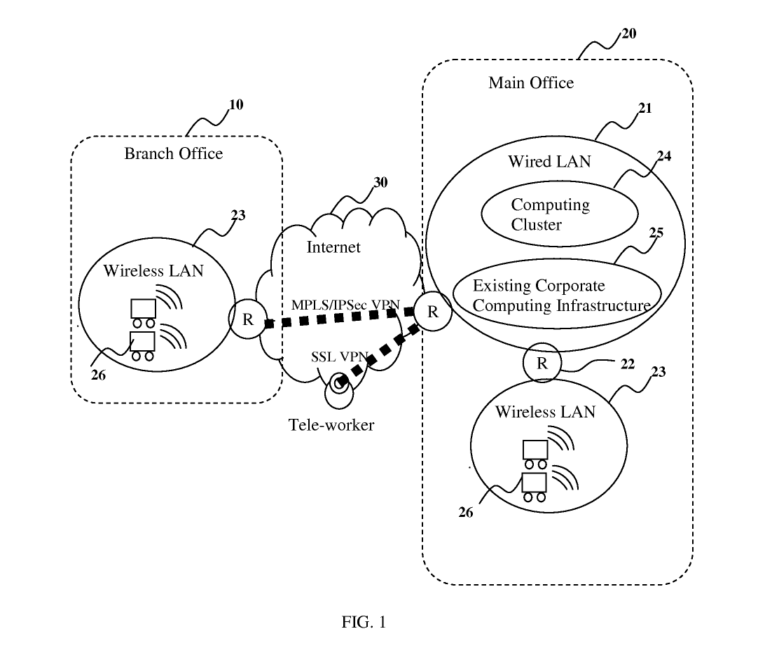

This invention is expected to be deployed in a corporate environment similar to one depicted in FIG. 1. The corporation may have one or more branch offices 10 in addition to its main office 20. Inside those branch and main offices, some autonomous and semi-autonomous robots 26 may be deployed, e.g., for handling office chores. Those robots 26 are connected to the corporate networking infrastructure, through wireless LAN or wired LAN and are capable of communicating to the computing cluster 24 via the corporate networking infrastructure. If some of those robots are to attain high level of mobility, then using wireless technology would make more sense. Typically, a branch office 10 is connected to the main office 20 through secure connections over the Internet 30. The main office 20 may have direct access to a corporate computing infrastructure 25, typically including data storage and computing servers.

The computing cluster 24 in this invention comprises a set of computers and robot management software developed on a distributed processing framework and run over the set of computers. Although physically the same set of computers can support typical business applications, such as enterprise resource planning software, in the corporate computing infrastructure 25, we would like to make the computing cluster 24 a distinct logical entity. We shall refer to the suite of typical business applications running over a set of computers as the existing corporate computing infrastructure 25. In other words, in this invention, the computing cluster 24, which is related to the robot system, is logically distinguished from the existing corporate computing infrastructure 25. Such distinction may facilitate the actual deployment of the robot system without disruption on the existing corporate computing infrastructure 25. That said, the computing cluster 24 and the existing corporate computing infrastructure 25 can also be physically distinct.

The computing cluster 24 handles the robot software computation in a distributed manner and maintains a knowledge database 68 in a distributed manner. The knowledge database 68 comprises data, processed or unprocessed, gathered by the office robots and a priori knowledge provided by system administrators. For example, the knowledge database 68 may comprise data of facial and speech characteristics of various employees and visitors and data related to inventory and physical properties. A distributed processing framework addresses the scalability issues. The knowledge database 68 grows as more data are collected. Moreover, as the knowledge database 68 grows, the robot software computation load may also grow as database search may take longer. Also, when more robots are added to the system, the robot software computation load increases. The advantage of using distributed processing framework is the ability to add more computers to the computing cluster 24 as the computing requirements increase. That minimizes CAPEX as new resource is added to the computing cluster 24 only when needed.

Centralizing the knowledge database 68 in the computing cluster 24 enables collaborative collection of data and sharing of data by the office robots 26. The office robots 26 gather data in various office locations and at various times and contribute to the knowledge database 68. The process makes the knowledge database 68 richer and more trustworthy. The computing cluster 24 using a distributed processing framework also provides data storage redundancy. That again alleviates the memory requirements on the office robots 26.

The OPEX is reduced through centralized management of robots 26. The computing cluster 24 supports robot management applications. Software upgrade can be pushed from the robot management applications to the robots 26. Also, the robot management applications can analyze the status and utilization of the robots 26 so that the information technology department can justify the expense of the robot system to corporate executives. Also, remote access to control the semi-autonomous robots 26 can also be authenticated and authorized by the robot management applications.

The computing cluster 24 is not limited to information gathered by the robots 26 in the system. It can integrate information retrieved from the existing corporate computing infrastructure 25. For example, the computing cluster 24 can access the employee workplace location, employee picture, and employee contact information, all stored in the existing corporate computing infrastructure 25. The computing cluster 24, on the other hand, may have stored an employee's images of various viewpoints, captured by the office robots 26. Among those images of various viewpoints, there may be one employee front-face image. That can be used to match the employee front-face picture stored in the existing corporate computing infrastructure 25. In that way, all information about the employee whose image is captured by the office robots 26 can be linked to the employee information stored in the existing corporate computing infrastructure 25. From then on, a robot 26 can recognize an employee from various viewpoints and use his contact information with the help of the computing cluster 24.

The computing cluster 24 may send decisions of robot software computation to office robots 26 to direct the office robots 26 to perform actions. Also, the computing cluster 24 may send messages, such as emails and voice mails, to office workers depending on the applications.

The computing cluster 24 can support robot collaboration. For example, there are multiple floor sweeping robots on the same floor. The computing cluster 24 can coordinate the robots to cover the whole floor.

The robot system in this invention supports tele-operators remotely controlling the robots. The tele-operators may control some specific actions of the robots, or they may provide missions for the robots to carry out autonomously. The tele-operators would need to view the robot environment visually, for example, through images captured by the robots and observe sensory data. In our preferred embodiment, the images captured by the robots are conveyed to the computing cluster 24, for analysis, and then to the tele-operators' computers, terminals, browsers, or application software.

The robot system in this invention assumes certain corporate networking infrastructure. The corporate networking infrastructure assumed is typical of modern corporate network deployment and is optimal for addressing the security and computation load aspects of the robot system.

The robot system's networking infrastructure may comprise wireless Local Area Networks (wireless LANs), wired Local Area Networks (wired LANs), and Virtual Private Networks (VPNs).

The wireless LANs are needed as the office robots are considered to be light-duty mobile computing devices in the robot system. Robots have the ability to move around and should not be confined by wired connections. On the other hand, the computing cluster is usually on a wired LAN, i.e., the many computers in the computing cluster are connected via wired LAN. Wired LAN provides lower latency and higher bandwidth relative to wireless LAN, so wired LAN is more appropriate for the distributed processing nature of the computing cluster. When office robots and the computing cluster are co-located, they communicate via wireless LAN and wired LAN.

VPNs are needed when office robots and the computing cluster are connected by the Internet, or when tele-operators' computers and the computing cluster are connected by the Internet. VPN provides secure connectivity and, in some case, service level agreement on quality of service.

Let's assume that the computing cluster 24 resides in the main office 20. Office robots 26 in branch offices 10 also need to access the computing cluster 24 through the Internet 30. We may deploy IPSec (Internet Protocol Security) VPN or MPLS (Multi-Protocol Label Switching) VPN between branch offices 10 and the main office 20. Then the office robots 26 in a branch office 10 communicate to the computing cluster 24 via wireless LAN 23 in the branch office 10, IPSec VPN or MPLS VPN over the Internet 30, and wired LAN 21 in the main office 20.

The advantage of using IPSec VPN or MPLS VPN is the encryption of data that protects from eavesdropping over the Internet 30. Moreover, the encryption and decryption is performed using dedicated VPN gateways so that the office robots 26 are not burdened with the computation load. That again echoes our theme of enabling office robots 26 to be light-duty mobile computing devices.

The use of SSL VPN in this invention is mainly for tele-operators remotely controlling semi-autonomous office robots 26 via web applications. The web applications need to first contact the robot management applications on the computing cluster 24 to obtain authorization. Then they can set up separate SSL connections to the office robots 26 directly without the computing cluster 24 in the middle or control the office robots 26 indirectly with the computing cluster 24 as the middleman.

The computing cluster 24 does not need to be located physically in the main office 20. It can be hosted by the ISP (Internet Service Provider) that provides the VPN service to the main office 20.

The adaptive distribution of robot software computation is at the heart of this invention as it offers multiple advantages. Firstly, the office robots can be treated light-duty mobile computing devices. They can be built cheaply and without over-provisioning in their processing power and memory capacity to accommodate current software and future software upgrades. Secondly, the office robots may end up having a number of versions with different processing power and memory capacity along the years of deployment. Yet, they may deliver the same software features thanks for the computing cluster taking part of the computing responsibilities from the robots.

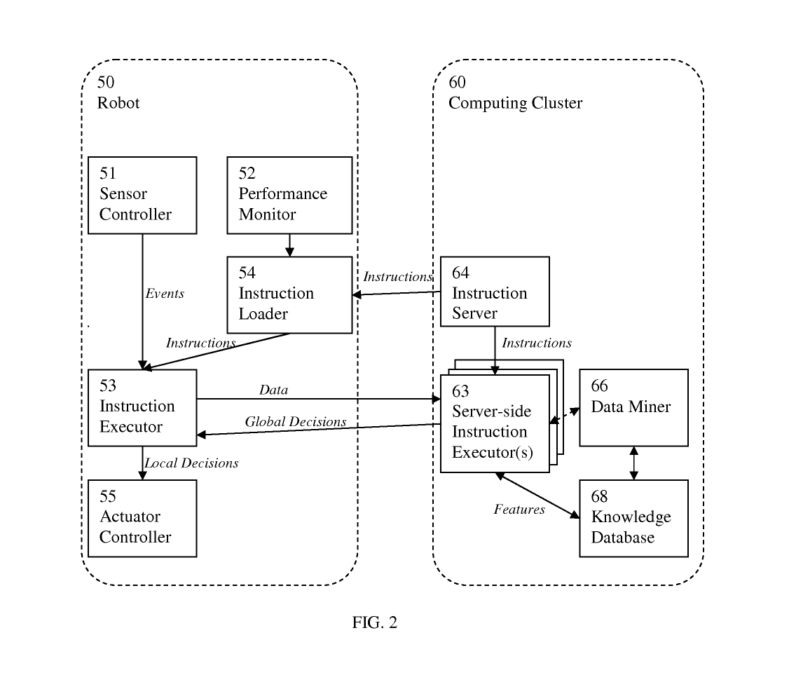

An embodiment of a robot 26 in the system is illustrated in FIG. 2. The robot 50 comprises five functional modules: a sensor controller 51, an actuator controller 55, a performance monitor 52, an instruction loader 54, and an instruction executor 53. Although those functional modules can be implemented in hardware, it is preferred to implement those functional modules as software modules on a processor that is being part of the robot 50.

The sensor controller 51 is responsible for all sensors on the robot 50, e.g., infrared sensors, microphones, and cameras. The sensor controller 51 feeds data collected on the sensors into the instruction executor 53.

The instruction executor 53 is responsible for executing instructions and capable of interacting with the sensor controller 51, the actuator controller 55, and the instruction loader 54. The instructions may be codes written in an interpretive programming language and compiled codes, or a combination of both.

In our preferred embodiment, the instructions are written in Java, a programming language. The instruction executor 53 comprises the Java virtual machine and some software that enables the instruction executor 53 to interact with the sensor controller 51, the actuator controller 55, and the instruction loader 54.

The performance monitor 52 is capable of collecting performance data about the instruction executor 53 executing the instructions and also about the communications where the instruction executor 53 is relaying data to the server-side instruction executor 63 on the computing cluster 60 via the corporate networking infrastructure. The performance data is a key deciding factor on how to distribute the instructions among the instructor executor 53 and the server-side instruction executor 63.

The instruction loader 54 is responsible for providing instructions to the instruction executor 53. The instructor loader 54 is capable of loading instructions from the instruction server 64 on the computing cluster 60 and providing the instructions to the instructor executor 53. The instructor loader 54 uses performance data collected the performance monitor 52 and may communicate the performance data to the instruction server 64. Also, the instructor loader 54 may keep some instructions locally in a persistent storage so that it does not need to rely on the instruction server 64 all the time. In one embodiment, the instructor loader 54 may decide what subset of instructions to be loaded from the instructor server 64. In our preferred embodiment, the instructor loader 54 passes the performance data to the instructor server 64 and let the instructor server 64 decides what subset of instructions to be loaded onto the instructor loader 54 and what functionally complementary subset of instructions to be executed by the server-side instructor executor 63.

The computing cluster 60 may also monitor the performance of communications between the instructor executor 53 of the robot 50 and the server-side instructor executor 63 of the computing cluster 60, but the performance monitor 52 has exclusive knowledge about the performance of the instructor executor 53. Also, the knowledge about the processing capability and memory capacity of the robot can also be used to decide on the distribution of the instructions.

The actuator controller 55 is responsible for all actuators on the robot, e.g., motors, light-emitting diodes (LEDs), display screens, and speakers. The actuator controller 55 services the local decisions generated by the instruction executor 53 resulting from executing the instructions.

An embodiment of the computing cluster 24 is illustrated in FIG. 2. The computing cluster 60 includes at least three functional modules: an instruction server 64, a knowledge database 68, and a variable number of server-side instruction executors 63.

The instruction server 64 is responsible for storing the instructions of the robot system software. In our preferred embodiment, the instruction server 64 further decides how to divide the instructions among an instructor executor 53 of a robot and the corresponding server-side instructor executor 63.

On the computing cluster 60, there is one server-side instruction executor corresponding to one instruction executor of a robot. For example, if there are a hundred robots 50 in the system, then there are a hundred server-side instruction executors 63. The server-side instruction executor 63 executes instructions provided by the instruction server 64. There may be a few ways of implementing the server-side instruction executors 63. Each server-side instruction executor can be a separate process. Alternatively, each server-side instruction executor represents a separate context while some or all server-side instructor executors are run in one process.

We would like to present the notion that there is one server-side instruction executor corresponding to one instruction executor so that the possibility of scaling the computing cluster is clear. Also, depending on factors including the performance data collected by the performance monitors of the robots in the system, each pair of instruction executor and server-side instruction executor may divide the instructions of the robot software differently.

The instructions implement the robot software in the robot system. The instruction server decides on how to divide the instructions for each pair of instruction executor and server-side instruction executor. The instructions are designed to be divisible. The instructions are modularized and data are passed between the modules of the instructions. When the instruction server provides a subset of instructions to an instruction executor, the instruction server provides a complementary subset of instructions to the corresponding server-side instruction executor.

When some modules of instructions require intensive processing power or memory capacity, they are more suitable to be executed by the server-side instruction executor. When some modules of instructions trigger a high bandwidth of data passing among them, they are more suitable to be put in the same subset of instructions to be executed by the instruction executor or the server-side instruction executor. When some modules of instructions are supposed to produce time-critical decisions on a robot, they are more suitable to be executed by the instruction executor on the robot.

To facilitate division of the instructions, there are several provisions in this invention. Firstly, the robot software is to be architected with linear dependency. Secondly, the instructions are to be hardware independent and interpreted at run-time.

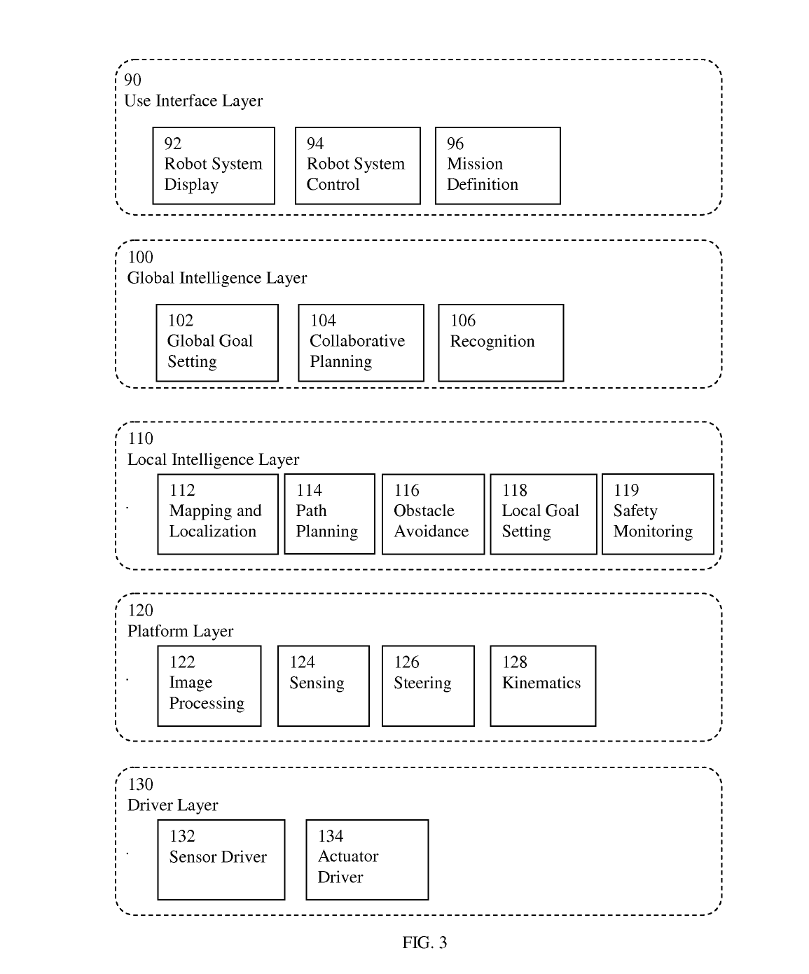

In an embodiment, the robot software stack is designed to have multiple layers with linear dependency. As in FIG. 3, the robot software stack is composed of a driver layer 130, a platform layer 120, a local intelligence layer 110, a global intelligence layer 100, and a user interface layer 90. The platform layer 120 depends on the driver layer 130, the local intelligence layer 110 on the platform layer 120, the global intelligence layer 100 on the local intelligence layer 110, and the global intelligence layer 100 on the user interface layer 90.

The driver layer 130 handles the low-level functions required to operate the robots. The driver layer 130 is composed of device drivers for the sensors and actuators of a robot. A robot may have a number of sensors and actuators. Sensors allow robots to receive information about a certain measurement of the environment or internal components. They may include touch, vision, distance measurement, etc. Actuators are devices for moving or controlling something. They may include motors, artificial muscles, grippers, effectors, etc. We simply use sensor driver module 132 and actuator driver module 134 to represent a set of sensor drivers and a set of actuator drivers, respectively. The actual modules in this layer depend on the sensors and actuators used in a robot and the operating system that the driver software runs on. In general, modules in this layer take actuator control inputs, from the platform layer 120, in engineering units, e.g., positions, velocities, forces, etc. and generate the low-level signals that create the corresponding actuation. Similarly, this layer contains modules that take raw sensor data, convert it into meaningful engineering units, and pass the sensor values to the platform layer 120. The sensor driver module 132 may be associated with the sensor controller 51. The actuator driver module 134 may be associated with the actuator controller 55.

The platform layer 120 contains functional modules that correspond to the physical hardware configuration of the robot. This layer frequently translates between the driver layer 130 and the local intelligence layer 110 by converting low-level information into a more complete picture. The platform layer 120 is composed of functional modules that are specific to the robots. The platform layer 120 may include a sensing module 124, a steering module 126, an image processing module 122, a kinematics module 128, etc. The sensing module 124 is responsible for processing various sensor data. The image processing module 122 is responsible for processing the images or videos captured via camera. The steering module 126 is responsible for locomotion of the robot. The kinematics module 128 is responsible for operating the actuators. Different robots have different capabilities and characteristics. For example, some robots have cameras while some do not. Some robots have grippers while some do not. Therefore, not all the mentioned functional modules are relevant for some robots, and the same functional module is implemented differently for different robots.

The local intelligence layer 110 consists of functional modules of the high-level control algorithms for the individual robots. The functional modules take system information such as position, velocity, or processed video images and make control decisions based on all of the feedback. This layer might include a mapping and localization module 112, a path planning module 114, an obstacle avoidance module 116, a local goal setting module 118, a safety monitoring module 119, etc. The mapping and localization module 112 is responsible for identifying the location and position of the robots. The path planning module 114 is responsible for guiding the robots through their environments. The obstacle avoidance module 116 is responsible for guiding the robots around their obstacles. The local goal setting module 118 is responsible for defining the missions of the robots. The safety monitoring module 119 is responsible for aborting or reversing the actions that are causing problems or hazards. There may be some dependencies within the functional modules. For example, the local goal setting module 118 may send control signals into the path planning module 114.

The global intelligence layer 100 consists of functional modules of the high-level control algorithms for the system of robots. The functional modules may include a global goal setting module 102 a collaborative planning module 104, a recognition module 106, etc. The functional modules in this layer may contribute to and make use of the knowledge database 68, which contains information collected by the robots in the system and a priori knowledge provided by system administrators. The global intelligence layer 100 uses information from the local intelligence layer 110 and provide decisions and control signals to the local intelligence layer 110. The global goal setting module 102 defines the missions for all the robots in the system and use the local goal setting module 118. The global goal setting module 102 may get inputs from and provide outputs to the user interface layer 90. The recognition module 106 is responsible for object recognition, face recognition, speech recognition, etc. and may use the knowledge database 68.

The user interface layer 90 is responsible for presenting the robot system to the system administrators and tele-operators and receiving inputs or missions from them. The user interface layer may include a robot system display module 92, a robot system control module 94, and a mission definition module 96. In one embodiment, this layer provides web applications to the system administrations and tele-operators to interact with the robot system. The system administration may modify the data to and operate on the knowledge database 68.

The linear dependency among the layers facilitates the partition of the instructions representing the robot system software stack to be executed on the instruction executor and the corresponding server-side instruction executor.

In one embodiment, there are a number of pre-built packages where each package presenting a way of partitioning the instructions. One of the-built packages is selected by the instruction server 64 based on the performance data.

In another embodiment, the instruction server 64 partitions the instructions dynamically based on the performance data and compile the partitions of the instructions on-the-fly before providing the subset of instructions to the executor loader 54 and the complementary subset of instructions to the server-side instruction executor 63.

When it comes to what makes good partitions of instructions, the global intelligence layer 100 should be executed on the computing cluster, and the driver layer 130 should be executed on the robot. It is more of a matter of how to partition the functional modules inside the local intelligence layer 110 and the platform layer 120. In our preferred embodiment, the safety monitoring module 119 is assigned to the robot's instruction executor 53. It is because the operations initiated by the safety monitoring module 119 are probably time-critical. It is also because the safety monitoring function should be local to the robot in case of network failure. The safety monitoring module 119 usually depends on the sensing module 124, the steering module 126, the kinematics module 128, and perhaps also on the image processing module 122. The image processing module 122 may consist of many algorithms, and some algorithms may be computationally intensive and not required by the safety monitoring module 119. Therefore, the partition of instructions is really about where to execute the local intelligence layer modules (except the safety monitoring module) and, part or whole of, the image processing module 122.

Some image processing algorithms may be computationally intensive, but it may also be bandwidth intensive to transfer the images from the robot to the computing cluster 24. The network bandwidth capacity may depend on the location of the robot, i.e., whether the Internet 30 is involved. Sometimes, it is more desirable for the robot to compress the images and send them to the computing cluster 24 and, sometimes, more desirable to extract the features from the images and send the features information to the computing cluster 24.

Implementing the functional modules in the global intelligence layer 100, the local intelligence layer 110, and the platform layer 120 in a platform independent programming language also facilitates the partitioning the instructions. In our preferred embodiment, we use Java as the programming language. The instruction executor 53 and the server-side instruction executor 63 encompass the JVMs (Java Virtual Machine).

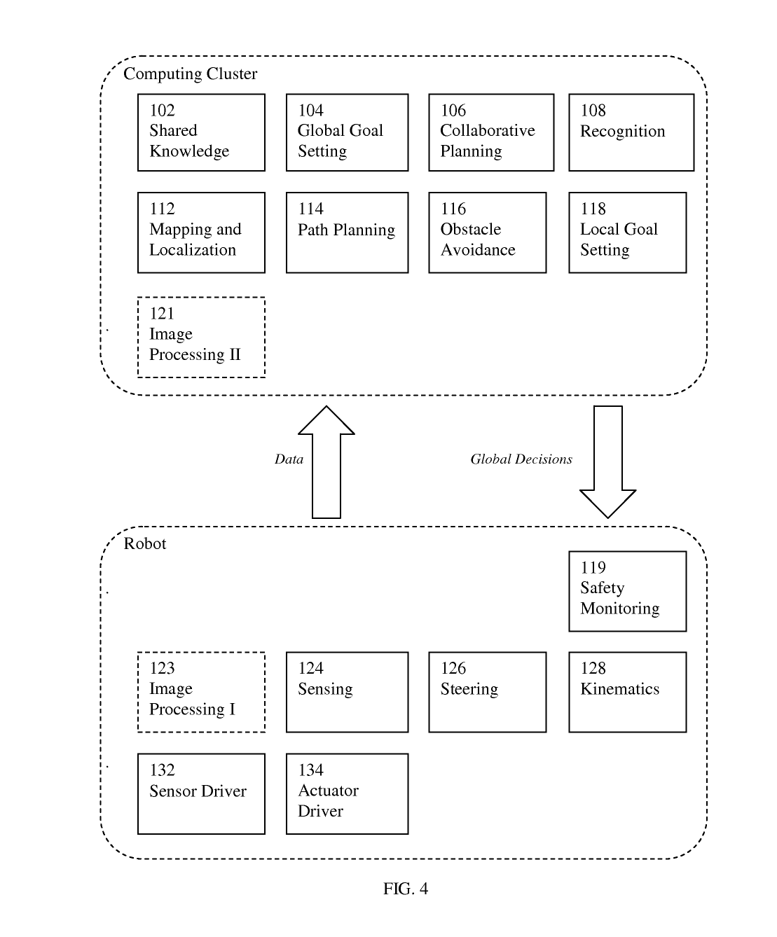

In partitioning the instructions, the performance monitor 52 plays an important role, as illustrated in FIG. 4. It is the performance monitor 52 to collect performance data about executing the instructions and communicating the data derived from executing those instructions from the robot to the computing cluster. The performance monitor 52 may even collect performance data when data are passed between modules of the instructions.

That said, the performance monitor 52 may estimate the instruction executor processing capacity and the network capacity by running engineered test instructions, as opposed to the instructions of the robot system software stack. Since the instruction executor processing capacity for a robot may seldom change, the performance monitor 52 may memorize about the instruction executor processing performance data and focus on assessing the run-time network performance.

The performance monitor 52 also collects performance data including network latency and bandwidth of the communications between the robot and the computing cluster 24 and also network latency and bandwidth of tele-operator sessions from the tele-operators' computers to the robot. Also, the performance monitor 52 exchanges keep-alives with the computing cluster 24 and synchronized timing information.

The synchronized timing information enables all robots in the system to synchronize their clocks. When images and sensory data are communicated across the robots and the computing cluster 24, the image processing module 122 and the sensing module 124 can correctly time-stamp the images and sensory data so that the instructions on the server-side instruction executors may be able to correlate the images and sensory data for correct analysis.

The keep-alives indicate the health of the communication channels. When a robot has lost contact with the computing cluster 24, the safety monitoring module 119 may pause the robot temporarily.

The network latency and bandwidth information, in addition to the processing capacity performance data, is useful for determining how the instructions should be partitioned. It is also useful for the image processing module 122 to scale down or up the degree of analysis. For example, it is used to control the degree of image compression, the rate of capturing images, and the image resolution so that the bandwidth required by the compressed images may fit into the networking infrastructure constraints.

Also, we may use the tele-operator session latency information to control the granularity of the mechanical movements, e.g., movements produced by the steering module 126 and the kinematics module 128. In a long latency environment, the tele-operator may not be able to observe the effect of the tele-operator's action, so it would be safer to slow down the mechanical movements; in a short latency environment, the tele-operator is able to adjust the effect of faster mechanical movements.

In our preferred embodiment, we have all communications from the robots to the computing cluster 24 all through direct peer-to-peer connections. Considering the presence of tele-operators, the partitioning of instructions has another aspect to consider. The deciding factors of what computation to be performed on the robots are application processing delay constraints and network bandwidth constraints in addition to computational complexity. For example, a robot is to capture video images and send them to a tele-operator. If the robot captures some video frames and sends them to the computing cluster 24 which in turns compresses the video frames and sends the compressed video stream to the tele-operator, that procedure may consume too much network bandwidth. It may be desirable that the robot first compresses the video frames to save some network bandwidth. Assuming that, if the computing cluster 24 processes the compressed video stream from the robots before relaying the compressed video stream to the tele-operators, that procedure may introduce a significant processing delay. That is a concern as the packet delay should be less than 250 ms to achieve good audio quality in real-time video delivery. Therefore, we suggest that the robots that possess video capturing capability should be capable of performing a decent video compression. Also, the corporate network infrastructure should support making a copy of the compressed video stream to the computing cluster 24 if needed. That allows the computing cluster 24 to intercept the compressed video stream, decompress it, and perform other useful analysis and decisions.

In yet another embodiment, the robots may communicate the computing cluster 24 through an intermediate server. For example, the video captured by the robots may go through a video server on the Internet, e.g., a Google GTalk server, before reaching the computing cluster 24 and the tele-operators. That embodiment has an advantage that the computing cluster 24 does not need to be bothered with video stream distribution and may focus on the robot system software stack.

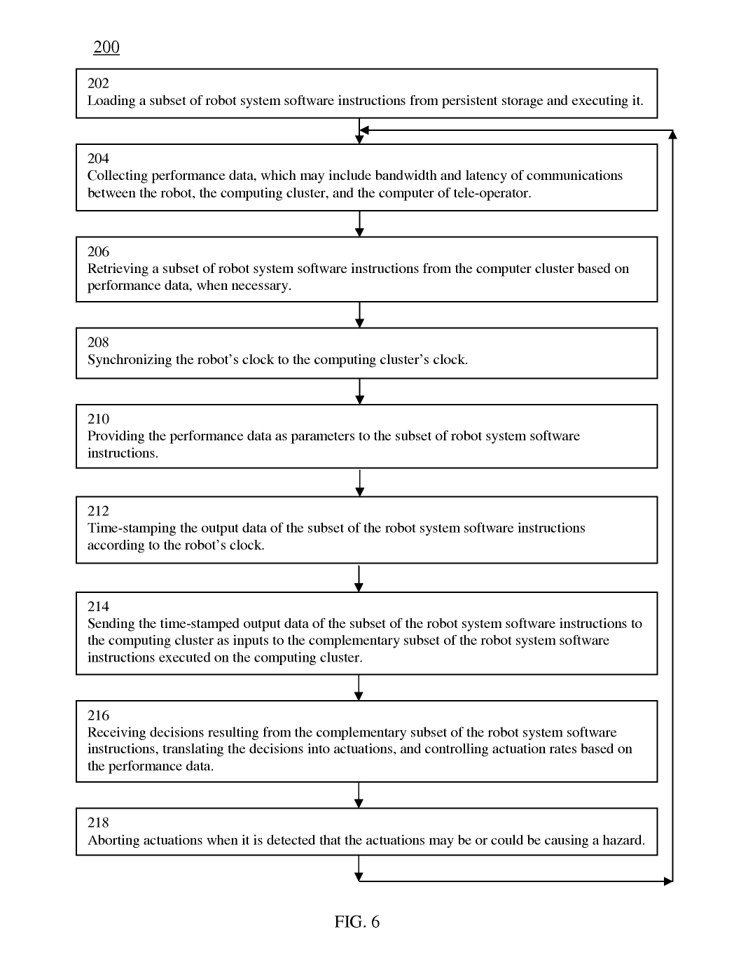

FIG. 6 illustrates one embodiment of a method of supporting distributed execution of robot system software instructions on a robot and a computing cluster, where the robot and the computing cluster are part of the robot system disclosed. The method 200 is implemented on the robot. In step 202, the robot first executes a subset of the robot system software instructions in its persistent storage. That subset may be saved during the previous operations of the robot so that the robot does not need to retrieve a subset of robot system software instructions from the computing cluster 24. If the robot is just new from the factory and has never contacted the computing cluster 24 before, the robot should still have a minimal subset of robot system software instructions in its persistent storage for bootstrapping purpose. In step 204, the robot collects performance data. The performance data should comprise the bandwidth and latency of the communications between the robot and the computing cluster 24 and the bandwidth and latency of the communications between the robot and the computer of tele-operator when there is a tele-operator controlling the robot. In step 206, the robot may retrieve a subset of robot system software instructions from the computing cluster 24 based on the performance data when necessary. In any case, the computing cluster 24 should be running a complementary subset of the robot system software instructions for the robot. In step 208, the robot synchronizes its clock to the clock of the computing cluster 24. In step 210, the robot executes the subset of the robot system software instructions using the performance data as parameters. The robot gets output data resulting from executing the subset of the robot system software instructions. The output data may comprise sensor data, images, and image features. The quantity and quality of the output data may depend on the performance data. In step 212, the robot timestamps the output data according to the robot's clock. In step 214, the robot sends the time-stamped output data to the computing cluster 24. The time-stamped output data are used as inputs to the complementary subset of the robot system software instructions executed on the computing cluster 24. Time-stamping the output data with the synchronized clock enables the computing cluster to make sense of the timing aspect of the output data. In step 216, the robot is to receive decisions from the computing cluster as a result of executing the complementary subset of the robot system software instructions. The robot is to perform actuations of the robot's actuators based on the decisions. In this step, the robot may control the actuation rates based on the performance data collected, mostly due to safety concerns. In step 218, the robot may abort the actuations when it detects that the actuations may be or could be causing a hazard. Then, the robot may repeat from step 204. Note that the steps described in FIG. 6 may not be executed in a neat order as described. The steps illustrate a general flow of processing on the robot. In fact, some steps may be swapped and some steps may be executed in parallel. Various embodiments may be possible.

It is understandable to those skilled in the art that all or part of the preceding embodiments can be implemented by hardware instructed by a program. The program may be stored in a computer-readable storage medium and be executed by a processor. The storage medium may be a magnetic disk, compact disk, Read-Only Memory (ROM), Random Access Memory (RAM), and so on.

The embodiments described above are illustrative examples and it should not be construed that the present invention is limited to these particular embodiments. Thus, various changes and modifications may be effected by one skilled in the art without departing from the spirit or scope of the invention as defined in the appended claims.

1. A robot system, comprising:
at least one robot, each of the at least one robot including a processor executing a subset of robot system software instructions;
a computing cluster executing a complementary subset of the robot system software instructions; and
a networking infrastructure that enables communications between the at least one robot and the computing cluster.

2. The robot system as in claim 1, wherein the processor collects performance data, the performance data comprising processing capacity of the processor and bandwidth and latency of communications between the processor and the computing cluster.

3. The robot system as in claim 2, wherein the robot system software instructions are partitioned into the subset of the robot system software instructions and the complementary subset of the robot system software instructions based on the performance data.

4. The robot system as in claim 2, wherein the processor uses the performance data as parameters for the subset of the robot system software instructions.

5. The robot system as in claim 2, wherein the processor uses the bandwidth and latency of communications between the processor and the computing cluster to control image processing complexity.

6. The robot system as in claim 1, wherein the networking infrastructure further enables communications between the processor and computers of tele-operators of the at least one robot.

7. The robot system as in claim 6, wherein the processor uses latency of the communications between the processor and computers of tele-operators of the at least one robot to control rates of actuations.

8. The robot system as in claim 1, wherein the subset of the robot system software instructions comprises safety monitoring instructions, the safety monitoring instructions responsible for aborting or reversing an actuation when the actuation is deemed causing a problem.

9. The robot system as in claim 1, wherein the processor may store the subset of the robot system software instructions in a local persistent storage.

10. The robot system as in claim 1, wherein the processor synchronizes a clock local to the processor to a clock of the computing cluster.

11. The robot system as in claim 10, wherein the processor communicates messages to the computing cluster via the networking infrastructure, the messages including data resulting from executing the subset of the robot system software instructions, the data being time-stamped according to the clock local to the processor.

12. The system as in claim 11, wherein the data being time-stamped according to the clock local to the processor are used as inputs to the complementary subset of the robot system software instructions.

13. The system as in claim 1, wherein the computing cluster comprises a knowledge database including data gathered by the at least one robot or resulting from executing the robot system software instructions.

14. The system as in claim 13, wherein the complementary subset of the robot system software instructions may use resources on an existing corporate computing infrastructure.

15. The system as in claim 14, wherein the complementary subset of the robot system software instructions may associate an employee data stored in the existing corporate computing infrastructure to another employee data stored in the knowledge database by matching employee front-face pictures.

16. The system as in claim 1, wherein the robot system software instructions are organized into a driver layer, a platform layer, a local intelligence layer, a global intelligence layer, and a user interface layer, the user interface layer depending on the global intelligence layer, the global intelligence layer depending on the local intelligence layer, the local intelligence layer depending on the platform layer, the platform layer depending on the driver layer.

17. The system as in claim 16, wherein the robot system software instructions are partitioned in such a way that the complementary subset of the robot system software instructions depends on the subset of the robot system software instructions.

18. The system as in claim 1, wherein each of the at least one robot may partition the robot system software instructions into the subset of the robot system software instructions and the complementary subset of the robot system software instructions differently.

19. A method for supporting distributed execution of robot system software instructions on a robot and a computing cluster, the method comprising the steps, executed in a processor of the robot, of:
collecting performance data, the performance data including bandwidth and latency of communications between the processor and the computing cluster;
executing a subset of the robot system software instructions retrieved from the computing cluster based on the performance data, wherein the computing cluster is to execute a complementary subset of the robot system software instructions;
synchronizing a clock of the robot to a clock of the computing cluster; and
sending data obtained from executing the subset of the robot system software instructions, the data being time-stamped according to the clock of the robot, the data being inputs to the complementary subset of the robot system software instructions.

20. A method for supporting distributed execution of robot system software instructions on a robot and a computing cluster, the robot being controlled by a tele-operator, the method comprising the steps, executed in a processor of the robot, of:
collecting performance data, the performance data including bandwidth and latency of communications between the processor and a computer of the tele-operator;
executing a subset of the robot system software instructions retrieved from the computing cluster based on the performance data, wherein the computing cluster is to execute a complementary subset of the robot system software instructions; and
adjusting actuation rates of actuators on the robot based on the performance data.
